(19) United States
(12) Patent Application Publication
(10) Pub. No.: US 2026/0210332 A1
(43) Pub. Date: Jul. 23, 2026

(54) TEMPORARY SUPPORTING DEVICE FOR WIND TURBINE BLADE

(71) Applicant: HUANENG POWER INTERNATIONAL INC. ANHUI WIND POWER BRANCH, HEFEI (CN)

(72) Inventors: BOSONG DING, HEFEI (CN); XIAOKANG CHU, HEFEI (CN); YAWEN HONG, HEFEI (CN); WEI YANG, HEFEI (CN); JI ZHAO, HEFEI (CN); WENCHAO LIU, HEFEI (CN); XUANBO WANG, HEFEI (CN)

(73) Assignee: HUANENG POWER INTERNATIONAL INC. ANHUI WIND POWER BRANCH, HEFEI (CN)

(21) Appl. No.: 19/392,369

(22) Filed: Nov. 18, 2025

(30) Foreign Application Priority Data
Jan. 17, 2025 (CN) 202510078180.3

(51) Int. Cl. F03D 13/00

(52) U.S. Cl. CPC F03D 13/00; F05B 2260/30

(57) ABSTRACT

The device includes a supporting device body, where the supporting device body includes a shell and a bottom plate, the shell is located above the bottom plate, a lifting block is arranged in the shell, and a lifting device is arranged in the shell, and a lifting end of the lifting device is connected with the lifting block, the shell is fixedly connected to an upper end of a fixed plate, the fixed plate is rotatably connected to an upper end of an support plate, the support plate is fixedly connected to an upper end of a support frame, and a lower end of the support frame is fixedly connected to an upper end of the bottom plate, and the lifting block is connected with a clamping device, and the clamping device clamps a wind turbine blade.

### CROSS-REFERENCE TO RELATED APPLICATIONS

This application claims priority of Chinese Patent Application No. 202510078180.3, filed on Jan. 17, 2025, the content of which is hereby incorporated by reference.

### TECHNICAL FIELD

The disclosure relates to the technical field of wind power generation equipment, in particular to a temporary supporting device for a wind turbine blade.

### BACKGROUND

In the manufacturing process or transportation process of wind turbine blades, it is usually necessary to temporarily support the blades to ensure the integrity and safety of the blades during manufacturing and transportation.

Existing devices for placing wind blades, such as a wind turbine blade placing frame provided in CN212424117U, have the following problems:
firstly, the height of the clamping plate for installing the wind turbine blades in the placing frame is fixed, and the placing height of the wind turbine blades may not be adjusted as required;
secondly, the clamping plate for installing the wind turbine blades in the placing frame is fixed to the mounting plate, which makes it inconvenient to adjust the placing orientation of the clamping plate as required.

### SUMMARY

The disclosure aims at a temporary supporting device for a wind turbine blade, which is used to solve at least one of the problems mentioned in the above background.

In order to solve the above technical problems, a temporary supporting device for a wind turbine blade is provided, and includes: a supporting device body, where the supporting device body includes a shell and a bottom plate, the shell is located above the bottom plate, a lifting block is arranged in the shell, and a lifting device is arranged in the shell, and a lifting end of the lifting device is connected with the lifting block, the shell is fixedly connected to an upper end of a fixed plate, the fixed plate is rotatably connected to an upper end of an support plate, the support plate is fixedly connected to an upper end of a support frame, and a lower end of the support frame is fixedly connected to an upper end of the bottom plate, and the lifting block is connected with a clamping device, and the clamping device clamps a wind turbine blade.

In the following, the technical scheme of the disclosure will be further described in detail through drawings and embodiments.

### BRIEF DESCRIPTION OF THE DRAWINGS

The accompanying drawings are provided to provide a further understanding of the disclosure and constitute a part of the specification, and together with the embodiments of the disclosure, serve to explain the disclosure and may not constitute a limitation of the disclosure. In the attached drawings:

FIG. 1 is an overall device diagram according to embodiments of the disclosure;

FIG. 2 is a top view of the partial structure according to embodiments of the disclosure;

FIG. 3 is a structural schematic diagram of one embodiment of a clamping part of the clamping device according to embodiments of the disclosure;

FIG. 4 is a sectional view of the clamping device according to embodiments of the disclosure;

FIG. 5 is a schematic structural diagram of the buffer device according to embodiments of the disclosure; and

FIG. 6 is a partial enlarged view at A position of the buffering device according to embodiments of the disclosure.

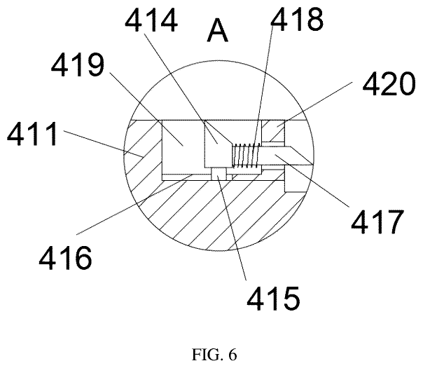

List of reference characters: 1 supporting device body; 11 shell; 12 bottom plate; 14 lead screw; 15 first guide rod; 16 second guide rod; 17 fixed plate; 18 first gear; 19 second gear; 110 bearing; 111 support plate; 112 first rotating shaft; 113 first motor; 114 support frame; 115 first bevel gear; 116 second bevel gear; 117 second rotating shaft; 118 second motor; 2 clamping device; 21 sliding rod; 22 locking block; 23 lifting block; 24 clamping part; 25 connecting rod; 26 clamping block; 27 second telescopic rod; 28 first pin shaft; 29 rocker rod; 210 first telescopic rod; 211 connecting plate; 212 first slider; 213 clamping head; 214 second pin shaft; 215 groove; 216 third pin shaft; 217 fixed block; 3 wind turbine blade; 4 buffering device; 41 first spring; 42 transverse plate; 43 fixed plate; 44 first vertical rod; 45 first conical block; 46 locking head; 47 second spring; 48 second vertical rod; 49 second conical block; 410 third vertical rod; 411 base; 412 buffer; 413 second groove; 414 third conical block; 415 second slider; 416 chute; 417 fourth conical block; 418 third spring; 419 first groove; and 420 first groove right wall.

### DETAILED DESCRIPTION OF THE EMBODIMENTS

In the following, the technical scheme in the embodiment of the disclosure will be described clearly and completely with reference to the attached drawings in the embodiment of the disclosure. Obviously, the described embodiment is only a part of the embodiments of the disclosure, but not all of the embodiments. Based on the embodiments in the disclosure, all other embodiments obtained by ordinary skilled in the field without creative efforts belong to the scope of protection of the disclosure.

In addition, in the disclosure, descriptions such as “first” and “second” are only used for descriptive purposes, and may not specifically refer to the order or sequence, nor are they used to limit the disclosure. The descriptions are only used to distinguish assemblies or operations described in the same technical terms, and may not be understood as indicating or implying relative importance or implicitly indicating the number of indicated technical features. Therefore, the features defined as “first” and “second” may explicitly or implicitly include at least one of these features. In addition, the technical solutions and technical features of each embodiment may be combined with each other, but they must be based on the realization of ordinary skilled in the field. When the combination of technical solutions is contradictory or impossible, it should be considered that the combination of technical solutions may not exist and is not within the scope of protection required by the disclosure

The disclosure provides the following embodiments.

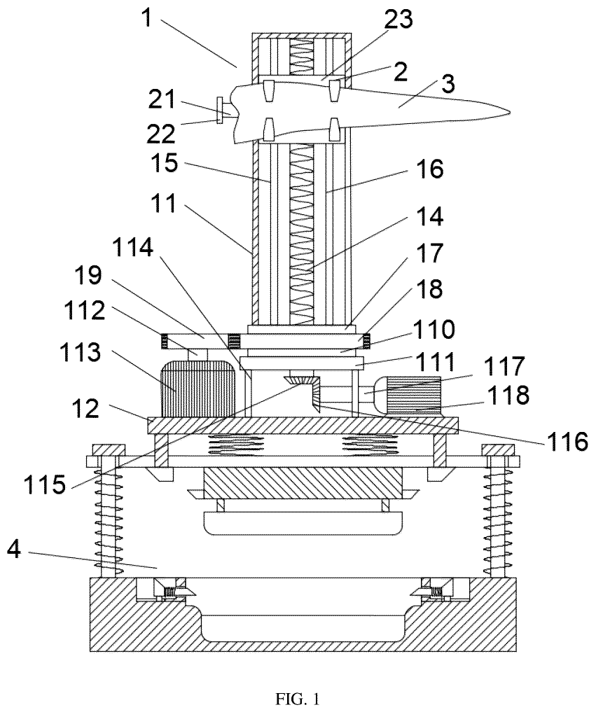

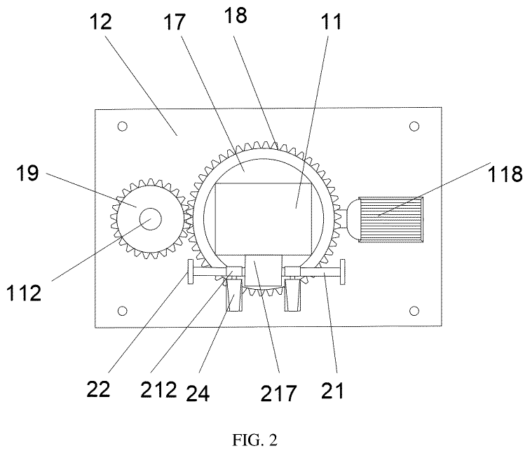

In Embodiment 1, the disclosure provides a temporary supporting device for a wind turbine blade, as shown in FIG. 1-FIG. 2. The temporary supporting device includes a supporting device body 1, where the supporting device body 1 includes a shell 11 and a bottom plate 12, the shell 11 is located above the bottom plate 12, a lifting block 23 is arranged in the shell 11, and a lifting device is arranged in the shell 11, and a lifting end of the lifting device is connected with the lifting block 23, the shell 11 is fixedly connected to an upper end of a fixed plate 17, the fixed plate 17 is rotatably connected to an upper end of an support plate 111, the support plate 111 is fixedly connected to an upper end of a support frame 114, and a lower end of the support frame 114 is fixedly connected to an upper end of the bottom plate 12, and the lifting block 23 is connected with a clamping device 2, and the clamping device 2 clamps a wind turbine blade 3.

Preferably, the lifting device includes:
a lead screw 14, where the lead screw 14 is vertically arranged; an upper end of the lead screw 14 is rotatably connected to an upper end of an inner wall of the shell 11; a lower end of the lead screw 14 penetrates through the fixed plate 17; the lower end of the lead screw 14 is fixedly connected with a first bevel gear 115; and the lifting block 23 is threadedly connected to a middle of the lead screw 14;
a first guide rod 15, where the first guide rod 15 is vertically arranged, an upper end of the first guide rod 15 is connected with an upper inner wall of the shell 11, and a lower end of the first guide rod 15 is connected with the fixed plate 17; and
a second guide rod 16, where the second guide rod 16 is vertically arranged, an upper end of the second guide rod 16 is connected to the upper inner wall of the shell 11, and a lower end of the second guide rod 16 is connected to the fixed plate 17, and the lifting block 23 is slidably sleeved on the first guide rod 15 and the second guide rod 16;
where a second bevel gear 116 is in meshing transmission with the first bevel gear 115, and one end of the second bevel gear 116 is connected with a second rotating shaft 117, the second rotating shaft 117 is connected with a second motor 118, the second motor 118 is fixedly connected with the upper end of the bottom plate 12. The lifting device of the disclosure may also be other existing lifting devices.

Preferably, the supporting device body 1 further includes:
a first gear 18, where the first gear 18 is fixedly sleeved on the fixed plate 17, the first gear 18 is rotatably connected with the support plate 111 through a bearing 110, and the first gear 18 is in meshing transmission with a second gear 19, a lower end of the second gear 19 is connected with a first rotating shaft 112, the first rotating shaft 112 is connected with a first motor 113, and the first motor 113 is fixedly connected with the upper end of the bottom plate 12.

The working principle and beneficial effects of the above technical scheme are as follows.

Firstly, in the disclosure, when a worker wants to use the temporary supporting device for a wind turbine blade, the second motor 118 is started, the second rotating shaft 117 drives the second bevel gear 116 to rotate, and the first bevel gear 115 meshed with the second bevel gear 116 also starts to rotate, then the lead screw 14 starts to rotate, and the lifting block 23 drives the clamping part 24 to move up and down to the required position. The disclosure may adjust the position of the clamping device 2 at will and the height of the wind turbine blade at will.

Secondly, when the worker needs to adjust the horizontal orientation of the wind turbine blades, the first motor 113 is started. At this time, the rotation of the first rotating shaft 112 drives the rotation of the second gear 19, and the first gear 18 meshed with the second gear 19 also starts to rotate. The fixed plate 17 is fixed on the first gear 18, and the shell 11 is fixed on the fixed plate 17, so the shell 11 starts to rotate, and the clamping device 2 in the shell 11 also starts to rotate. The wind turbine blade may be adjusted to a proper angle, and the bearing 110 is arranged below the first gear 18, so that the rotation of the first gear 18 will not be affected. The disclosure effectively solves the complicated procedures for workers to assemble and disassemble, and may adjust the wind turbine blade to a required angle.

The disclosure solves the following problems proposed in the background technology: the existing device for placing wind blades, such as a wind turbine blade placing frame provided in CN212424117U, has the following problems: firstly, the height of the clamping plate for installing wind blades in the placing frame is fixed, and the placing height of wind turbine blades may not be adjusted as required; secondly, the clamping plate for installing the wind blades in the placing frame is fixed on the mounting plate, which is inconvenient to adjust the placing orientation of the clamping plate as required.

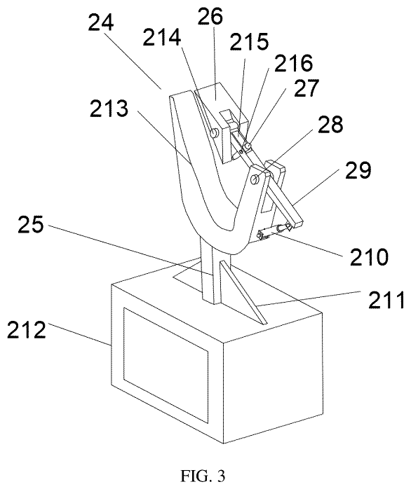

Embodiment 2, based on Embodiment 1, as shown in FIGS. 1 and 3, the clamping device 2 includes:

a fixed block 217 and sliding rods 21, where left and right ends of the fixed block 217 are fixedly connected with each of the sliding rods 21; a rear wall of the fixed block 217 is fixed on a front wall of the lifting block 23; an outer end of each of the sliding rods 21 is fixedly connected with a locking block 22; and a first slider 212 is limited and installed on corresponding one of the sliding rods 21; where, the sliding rod 21 may be provided with multiple first connecting holes at intervals left and right, and the first slider 212 may be provided with a second connecting hole, and the first slider 212 may be fixed relative to the sliding rod 21 by connecting the first connecting hole and the second connecting hole with a connector which may be a bolt; and

a connecting rod 25, where one end of the connecting rod 25 is fixedly connected to a front side of the first slider 212, and an other end of the connecting rod 25 is fixedly connected with a clamping part 24; and connecting plates 211 are further arranged on upper and lower sides of the connecting rod 25, and the connecting plates 211 are fixedly connected with the first slider 212.

Preferably, the clamping part 24 includes:
a clamping head 213, where the clamping head 213 is fixedly connected to one end of the connecting rod 25, and an outer side of a lower end of the clamping head 213 is hinged with a first telescopic rod 210, and an other end of the first telescopic rod 210 is hinged with a lower end of a rocker rod 29, and a middle of the rocker rod 29 is rotatably connected with the clamping head 213 through a first pin shaft 28; and
a clamping block 26, where the clamping block 26 is connected to an upper end of the rocker rod 29.

Preferably, the clamping block 26 is rotatably connected to the upper end of the rocker rod 29 through a second pin shaft 214, the upper end of the rocker rod 29 is provided with a groove 215, and a lower end of the clamping block 26 is provided with a second telescopic rod 27, an upper end of the second telescopic rod 27 movably penetrates through the groove 215, and the second telescopic rod 27 is rotatably connected with the rocker rod 29 through a third pin shaft 216.

The working principle and beneficial effects of the above technical scheme are as follows: in the disclosure, the clamping parts 24 located on both sides of the sliding rod 21 may be adjusted left and right to meet the different length clamping requirements of each supporting device body, the position of the clamping block 26 may be adjusted at one time under the action of the first telescopic rod 210 pulling the rocker rod 29, and the position of the clamping block 26 relative to the rocker rod 29 may be further adjusted under the action of the second telescopic rod. Under the action of the clamping block 26 and the clamping head 213, the wind turbine blade may be clamped; and the position of the clamping block 26 is adjusted twice, so that different clamp requirements may be met.

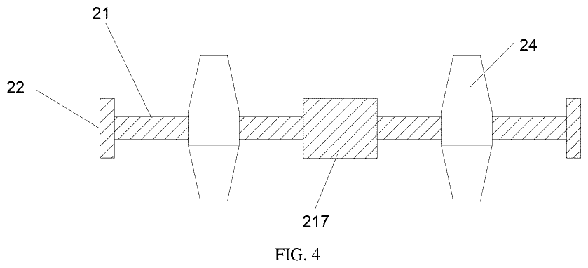

Embodiment 3, based on Embodiment 1 or 2, as shown in FIG. 4, a buffering device 4 is arranged below the bottom plate 12, and the buffering device 4 includes:

first vertical rods 44, where the first vertical rods 44 are symmetrical left and right, and upper ends of the first vertical rods 44 are fixed at a lower end of the bottom plate 12, and a lower end of each of the first vertical rods 44 is connected with a first conical block 45, and the first vertical rods 44 penetrate through a transverse plate 42, and multiple first spring are arranged between the transverse plate 42 and the bottom plate 12;

second vertical rods 48, where the second vertical rods 44 are symmetrical left and right, and lower ends of the second vertical rods 44 are fixed on a base 411, upper ends of the second vertical rods 44 are fixedly connected with a locking head 46, and the second vertical rods 48 penetrate through the transverse plate 42, and an outer side of each of the second vertical rods 48 is further provided with a second spring 47, the second spring 47 is located between the transverse plate 42 and the base 411; and

third vertical rods 410, where upper ends of the third vertical rods 410 are connected with a fixed plate 43, and lower ends of the third vertical rods 410 are connected with a buffer 412; an upper end of the fixed plate 43 is fixed at a lower end of the transverse plate 42, and second conical blocks 49 are further arranged at both ends of the fixed plate 43.

Preferably, the buffering device 4 further includes: two left-right symmetrical support assemblies, and one of the support assemblies on a left side includes:
a third conical block 414, where the third conical block 414 is high on a left and low on a right and is located in a first groove 419 in the base 411, and a second slider 415 is fixed at a lower end of the third conical block 414, the second slider 415 slides in the chute 416 in the base 411, a right end of the third conical block 414 is connected with a fourth conical block 417, and the fourth conical block 417 slides and penetrates a first groove right wall 420, and a third spring 418 is fixedly connected between the fourth conical block 417 and the first groove right wall 420; and
a second groove 413, where the second groove 413 is located in the base 411, and an upper end inside the base 411 is open.

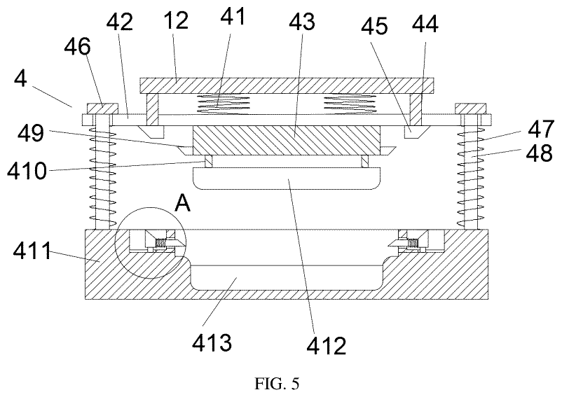

As shown in FIG. 5, the first conical blocks 45 on the left and right sides are symmetrical, and the left side of the first conical block 45 on the left side is provided with a first conical surface with a high left and a low right. The second conical blocks 49 on the left and right sides are symmetrical left and right, and the left side of the second conical block 49 on the left side is provided with a second conical surface with high left and low right. The fourth conical blocks 417 on the left and right sides are symmetrical left and right, and the fourth conical block 417 on the left side is high on the left and low on the right.

The buffer 412 may be a spring, a spring rod or an air bag.

The working principle and beneficial effects of the above technical scheme are as follows: in the disclosure, when the clamping device 2 has been clamped to the wind turbine blade 3, the bottom plate 12 is subjected to downward pressure, and the first spring 41 starts to compress downward, and the first vertical rod 44 connected with the bottom plate 12 drives the first conical block 45 to move downward. When the bottom plate 12 presses the transverse plate 42 to a certain extent, the transverse plate 42 also start to press the second spring 47. The fixed plate 43 fixed on the lower side of the transverse plate 42 starts to move downwards, and the buffer 412 connected with the fixed plate 43 through the third vertical rod 410 also starts to move downwards. When the two first conical blocks 45 at the lower end of the first vertical rod 44 contact with the third conical blocks 414 at both ends of the first groove 419, the first conical blocks 45 start to press the third conical blocks 414, and at this time, the third conical block 414 on the left start to move to the left, the third conical block 414 on the right side starts to move to the right, and the third spring 418 gradually expands, and the fourth conical block 417 connected with the third conical block 414 starts to move in the direction of the third conical block 414. The third conical block 414 and the third spring 418 buffer the whole support composed of the transverse plate 42 and the buffer 412, thus ensuring the stable decline of the whole support. When the buffer 412 completely enters the second groove 413, the bottom plate 12 is not pressed down any more. At this time, the first spring 41, the second spring 47 and the third spring 418 exert elastic force. The first spring 41 gives upward elastic force to the bottom plate 12, the second spring 47 gives upward elastic force to the transverse plate 42, and the third spring 418 pulls the third conical block 414 to move inward. At this time, the fourth conical block 417 moves along with the third conical block 414 and gathers inward, so that the conical block 4 417 blocks the second conical block 49 from moving upward, and the buffer 412 may not move at this time, thus achieving the effect of stable buffering. Moreover, the first conical block 45 and the third conical block 414 may support the lateral sides of the whole support, while the buffer 412 supports the middle part of the whole support, thus ensuring the support stability of the whole support.

Embodiment 4: on the basis of any one of Embodiments 1-3, the number of the supporting device bodies is multiple, and each of the supporting device bodies is supported at a different position in the length direction of the wind turbine blade;
and further includes:
multiple first detection modules, where the first detection modules are corresponding to the supporting device bodies one by one, where the first detection modules include first force sensors and timers, and the first force sensors are respectively arranged at different contact parts of each of the supporting device bodied with the wind turbine blade;
a first calculation module, configured for periodically calculating the first instability degree, the second instability degree and the comprehensive instability degree at each of the supporting device bodies based on the first detection module, and obtaining the instability result [Gᵢ₁, Gᵢ₂, Gᵢ₃];

$${G}_{i 1} = \frac{{{\sum }_{j = 1}^{M} [ \vert \frac{{F}_{i j} - {f}_{i j}}{{f}_{i j}} \vert * \frac{{F}_{ij}^{′} - {F}_{ij}^{″}}{{F}_{i j}} ]}^{{a}_{i j}}}{M} ;$$

$${G}_{i 2} = \frac{[ \begin{matrix}{\sum }_{k = 2}^{N} \frac{1}{( K - 1 )} {( \frac{{F}_{i j k} - {F}_{i j ( k - 1 )}}{{F}_{i j 0}} * \frac{{δ}_{i j}}{N} )}^{{β}_{i j}} + \\ max ( {( \frac{{F}_{i j k} - {F}_{i j ( k - 1 )}}{{F}_{i j 0}} * \frac{{δ}_{i j}}{N} )}^{{β}_{i j}} )\end{matrix} ]}{2} ;$$

$${G}_{i 3} = [ {G}_{i 1} * l g [ ( 10 + {G}_{i 2} ) ] ] ;$$

Gᵢ₁ is the first instability degree at an i-th supporting device, Gᵢ₂ is the second instability degree at the i-th supporting device, and Gᵢ₃ is the comprehensive instability degree at the i-th supporting device; M is a total number of the first force sensors at each of the supporting device bodies, Fᵢⱼ is an average detection value of a j-th first force sensor at the i-th supporting device in a current detection cycle, fᵢ₁ is a preset reference value of the j-th force sensor at the i-th supporting device, lg is the logarithm based on 10, N is a total detection times of each of the force sensors in the current detection cycle, and Fᵢⱼₖ is a k-th detection value of the j-th first force sensor at the i-th supporting device in the current detection cycle; and Fᵢⱼ₍ₖ₋₁₎ is the k−1-th detection value of the j-th first force sensor at the i-th supporting device in the current detection cycle; δᵢⱼ is the number of times that Fᵢⱼₖ−Fᵢⱼ₍ₖ₋₁₎ is greater than the corresponding first preset value (0.8Fᵢⱼ₀ is desirable) in the N times of detection in the current detection cycle; αᵢⱼ is an influence coefficient of abnormal force on the support stability of the wind turbine blade in the position where the j-th first force sensor is located at the i-th supporting device; βᵢⱼ is an influence coefficient of collision on the wind turbine blade in the position where the j-th first force sensor is located at the i-th supporting device;

$${F}_{i j}^{′}$$

is a maximum detection value of the j-th first force sensor at the i-th supporting device in the current detection period, and

$${F}_{i j}^{″}$$

is a minimum detection value of the j-th first force sensor at the i-th supporting device n t current detection period; Fᵢⱼ₀ is a maximum allowable value corresponding to Fᵢⱼₖ−Fᵢⱼ₍ₖ₋₁₎; max represents the maximum value;
a first alarm module, if any one of Gᵢ₁>Gᵢ₁₀, Gᵢ₂>Gᵢ₂₀, and Gᵢ₃>Gᵢ₃₀ is satisfied, the first alarm module gives an alarm; Gᵢ₁₀, Gᵢ₂₀, and Gᵢ₃₀ are the maximum allowable values of Gᵢ₁, Gᵢ₂, and Gᵢ₃ respectively;
a model building module, configured for building a wind turbine blade model and marking the position of each of the supporting device bodies;
a first marking module, configured for determining a Gᵢ₁>0.8Gᵢ₁₀ supporting device body as the first target supporting device body, taking the center of the contact part of the wind turbine blade model with the first target device body as the first marking point, determining the first centers of all the first marking points, and obtaining the first distance D₁ between the first center and the gravity center of the wind turbine blade model;

a second marking module, configured for determining a Gᵢ₂>0.8Gᵢ₂₀ supporting device body as the second target supporting device body, taking the center of the contact part of the wind turbine blade model with the second target device body as the second marking point, determining the second centers of all the second marking points, and obtaining the second distance D₂ between the second center and the gravity center of the wind turbine blade model;
a third marking module, configured for determining a Gᵢ₃>0.8Gᵢ₃₀ supporting device body as the third target supporting device body, taking the center of the contact part of the wind turbine blade model with the third target device body as the third marking point, determining the third centers of all the third marking points, and obtaining the third distance D₃ between the third center and the gravity center of the wind turbine blade model;
a second calculation module, configured for obtaining the first evaluation result G₁, the second evaluation result G₂ and the third evaluation result G₃ based on the first calculation module, the first marking module, the second marking module and the third marking module;

$${G}_{1} = ( 1 + {e}^{\frac{{D}_{1}}{{D}_{10}}} ) {\sum }_{i = 1}^{M} {G}_{i 1} ;$$

$${G}_{2} = ( 1 + {e}^{\frac{{D}_{2}}{{D}_{20}}} ) {\sum }_{i = 1}^{M} {G}_{i 2} ;$$

$${G}_{3} = ( 1 + {e}^{\frac{{D}_{3}}{{D}_{30}}} ) {\sum }_{i = 1}^{M} {G}_{i 3} ;$$

e is a natural constant; PG
a second alarm module, the second alarm module gives an alarm when any one of G₁>G₁₀, G₂>G₂₀, and G₃>G₃₀ is satisfied; G₁₀, G₂₀, and G₃₀ are the maximum allowable values corresponding to G₁, G₂, and G₃ respectively. D₁₀, D₂₀, and D₃₀ are standard values corresponding to the first distance D₁ between the first center and the gravity center of the wind turbine blade model, the second distance D₂ between the second center and the gravity center of the wind turbine blade model, and the third distance D₃ between the third center and the gravity center of the wind turbine blade model, respectively.

The technical scheme has the following beneficial effects.

Firstly, the first force sensors are respectively arranged at different contact parts of each of the supporting device bodies with the wind turbine blade, and are configured for obtaining the stress state in the process of supporting the wind turbine blade;

the first instability degree reflects the actual average stress state

$$\frac{{F}_{i j} - {f}_{i j}}{{f}_{i j}}$$

of different contact parts of the supporting device body with the wind turbine blade and the overall stress change state

$$\frac{{F}_{ij}^{′} - {F}_{ij}^{″}}{{F}_{ij}} ,$$

when the first instability degree is abnormal, the support effect on the wind turbine blade may be affected due to the abnormal support force;

the second instability degree reflects the stress change state (collision state) of the supporting device body, which is specifically based on the stress change value and abnormal change times δᵢⱼ of adjacent detections, and considering the influence coefficient of collision on the wind turbine blades, the calculation is more reliable; when the stress change state (collision state) of the supporting device body is abnormal, it is necessary to give an alarm to avoid affecting the quality of the wind turbine blades;

the third instability degree is combined with the first instability degree and the second instability degree to determine the comprehensive state, and when the comprehensive state is abnormal, it will also give an alarm to remind adjustment in time.

Secondly, the first marking module is configured for marking the wind turbine blade model based on the position of the supporting device body whose the first instability degree is close to abnormality, and obtaining the central position of the area mainly affected by the first instability degree, and obtaining the first distance from the wind turbine blade model;

the second marking module is configured for marking the wind turbine blade model based on the position of the supporting device body whose the second instability degree is close to abnormality, and obtaining the central position of the area mainly affected by the second instability degree, and obtaining the second distance from the wind turbine blade model;

the third marking module is configured for marking the wind turbine blade model based on the position of the supporting device body whose the third instability degree is close to abnormality, and obtaining the central position of the area mainly affected by the third instability degree, and obtaining the third distance from the wind turbine blade model;

the supporting stress state of all supporting device bodies on the whole wind turbine fan blade is determined in combination with the first distance, and the collision state of all supporting device bodies on the wind turbine blade is determined in combination with the second distance, and the comprehensive supporting state of all supporting device bodies on the wind turbine blade is determined in combination with the third distance; when the supporting stress state, collision state and comprehensive supporting state are timely alarmed to remind adjustment.

For those skilled in the art, obviously, the disclosure is not limited to the details of the above-mentioned exemplary embodiments, and the disclosure may be realized in other specific forms without departing from the spirit or essential characteristics of the disclosure. Therefore, no matter from which point of view, the embodiments should be considered in all aspects as illustrative and not restrictive, and the scope of the disclosure is defined by the appended claims rather than the above description, so the disclosure is intended to embrace all changes that come within the meaning and range of equivalents of the claims. Any reference signs in the claims may not be construed as limiting the claims concerned.

What is claimed is:

1. A temporary supporting device for a wind turbine blade, comprising a supporting device body, wherein the supporting device body comprises a shell and a bottom plate, the shell is located above the bottom plate, a lifting block is arranged in the shell, and a lifting device is arranged in the shell, and a lifting end of the lifting device is connected with the lifting block, the shell is fixedly connected to an upper end of a fixed plate, the fixed plate is rotatably connected to an upper end of an support plate, the support plate is fixedly connected to an upper end of a support frame, and a lower end of the support frame is fixedly connected to an upper end of the bottom plate, and the lifting block is connected with a clamping device, and the clamping device clamps a wind turbine blade.

2. The temporary supporting device for a wind turbine blade according to claim 1, the lifting device comprising:
a lead screw, wherein the lead screw is vertically arranged; an upper end of the lead screw is rotatably connected to an upper end of an inner wall of the shell; a lower end of the lead screw penetrates through the fixed plate; the lower end of the lead screw is fixedly connected with a first bevel gear; and the lifting block is threadedly connected to a middle of the lead screw;
a first guide rod, wherein the first guide rod is vertically arranged, an upper end of the first guide rod is connected with an upper inner wall of the shell, and a lower end of the first guide rod is connected with the fixed plate; and
a second guide rod, wherein the second guide rod is vertically arranged, an upper end of the second guide rod is connected to the upper inner wall of the shell, and a lower end of the second guide rod is connected to the fixed plate, and the lifting block is slidably sleeved on the first guide rod and the second guide rod;
wherein a second bevel gear is in meshing transmission with the first bevel gear, and one end of the second bevel gear is connected with a second rotating shaft, the second rotating shaft is connected with a second motor, the second motor is fixedly connected with the upper end of the bottom plate.

3. The temporary supporting device for a wind turbine blade according to claim 2, the supporting device body further comprising:
a first gear, wherein the first gear is fixedly sleeved on the fixed plate, the first gear is rotatably connected with the support plate through a bearing, and the first gear is in meshing transmission with a second gear, a lower end of the second gear is connected with a first rotating shaft, the first rotating shaft is connected with a first motor, and the first motor is fixedly connected with the upper end of the bottom plate.

4. The temporary supporting device for a wind turbine blade according to claim 1, the clamping device comprising:
a fixed block and sliding rods, wherein left and right ends of the fixed block are fixedly connected with each of the sliding rods; a rear wall of the fixed block is fixed on a front wall of the lifting block; an outer end of each of the sliding rods is fixedly connected with a locking block; and a first slider is limited and installed on corresponding one of the sliding rods; and
a connecting rod, wherein one end of the connecting rod is fixedly connected to a front side of the first slider, and an other end of the connecting rod is fixedly connected with a clamping part; and connecting plates are further arranged on upper and lower sides of the connecting rod, and the connecting plates are fixedly connected with the first slider.

5. The temporary supporting device for a wind turbine blade according to claim 4, the clamping part comprising:
a clamping head, wherein the clamping head is fixedly connected to one end of the connecting rod, and an outer side of a lower end of the clamping head is hinged with a first telescopic rod, and an other end of the first telescopic rod is hinged with a lower end of a rocker rod, and a middle of the rocker rod is rotatably connected with the clamping head through a first pin shaft; and
a clamping block, wherein the clamping block is connected to an upper end of the rocker rod.

6. The temporary supporting device for a wind turbine blade according to claim 5, wherein the clamping block is rotatably connected to the upper end of the rocker rod through a second pin shaft, the upper end of the rocker rod is provided with a groove, and a lower end of the clamping block is provided with a second telescopic rod, an upper end of the second telescopic rod movably penetrates through the groove, and the second telescopic rod is rotatably connected with the rocker rod through a third pin shaft.

7. The temporary supporting device for a wind turbine blade according to claim 1, wherein a buffering device is arranged below the bottom plate, and the buffering device comprises:
first vertical rods, wherein the first vertical rods are symmetrical left and right, and upper ends of the first vertical rods are fixed at a lower end of the bottom plate, and a lower end of each of the first vertical rods is connected with a first conical block, and the first vertical rods penetrate through a transverse plate, and a plurality of first spring are arranged between the transverse plate and the bottom plate;
second vertical rods, wherein the second vertical rods are symmetrical left and right, and lower ends of the second vertical rods are fixed on a base, upper ends of the second vertical rods are fixedly connected with a locking head, and the second vertical rods penetrate through the transverse plate, and an outer side of each of the second vertical rods is further provided with a second spring, the second spring is located between the transverse plate and the base; and
third vertical rods, wherein upper ends of the third vertical rods are connected with a fixed plate, and lower ends of the third vertical rods are connected with a buffer; an upper end of the fixed plate is fixed at a lower end of the transverse plate, and second conical blocks are further arranged at both ends of the fixed plate.

8. The temporary supporting device for a wind turbine blade according to claim 7, wherein the buffering device further comprises: two left-right symmetrical support assemblies, and one of the support assemblies on a left side comprises:
a third conical block, wherein the third conical block is high on a left and low on a right and is located in a first groove in the base, and a second slider is fixed at a lower end of the third conical block, the second slider slides in the chute in the base, a right end of the third conical block is connected with a fourth conical block, and the fourth conical block slides and penetrates a first groove right wall, and a third spring is fixedly connected between the fourth conical block and the first groove right wall; and
a second groove, wherein the second groove is located in the base, and an upper end inside the base is open.
